(19) United States
(12) Patent Application Publication
(10) Pub. No.: US 2008/0320459 A1
(43) Pub. Date: Dec. 25, 2008

(54) Method And Systems For Providing Concurrency Control For Addressable Entities

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 11/766,948

(22) Filed: Jun. 22, 2007

(51) Int. Cl. G06F 9/44

(52) U.S. Cl. 717/162

(57) ABSTRACT

Methods and systems are described for providing concurrency control for addressable entities. In one embodiment, a concurrency policy is associated with an addressable entity in an executable program component generated from source code, the concurrency policy controlling an order of access by a plurality of runtime processes each executing machine code instructions for accessing the addressable entity, the machine code instructions generated from source code, wherein the concurrency policy is associated with the addressable entity independent of the source code of the executable program component and the source code of the machine code instructions. An attempt to access the addressable entity by a machine code instruction executed by a runtime process of the plurality of runtime processes is detected. The machine code instruction is allowed to access the addressable entity based on the concurrency policy.

### RELATED APPLICATIONS

This application is related to U.S. patent application Ser. No. ______, titled “METHOD AND SYSTEMS FOR PROVIDING TRANSACTION SUPPORT FOR EXECUTABLE PROGRAM COMPONENTS”, filed on even date herewith, the entire disclosure of which is here incorporated by reference.

### BACKGROUND

Today's executable programs include addressable entities. Some addressable entities in an executable program require concurrency control. For example, some instructions and data must be limited to processing by one thread or process of execution at a time. Other addressable entities operate with multiple concurrent or overlapping readers. If such an addressable entity is written to, it is locked for the write operation allowing access to only the writer until the write is completed.

Today's concurrency control systems require a source code representation that includes a concurrency related source code instruction for declaring or defining an addressable entity and a concurrency related source code instruction accessing the addressable entity to associate a concurrency policy with the addressable entity of an executable program. The inclusion of concurrency related source code associates the concurrency policy with the addressable entity.

For example, concurrency in JAVA™ is configured through the use of the JAVA keyword “synchronized” in the coding of a class or method. In “C” and “C++,” an object code library provides concurrency utilities such as semaphores and locking functions. The semaphores and locking functions must be referenced in a source code representation including a symbol associated with the object code library, such as a function name. The object code library must then be loaded and linked so that the symbol can be resolved allowing the concurrency policy of the invoked function to be performed.

Today's concurrency utilities are operating system specific in some cases. This makes a program that uses such utilities specific to the operating system. Thus, a source code representation using a symbol of such a concurrency function is not portable to other operating systems. Further, such language specific and system specific techniques make associating a concurrency policy with an addressable entity that is shared between cross-language executable program components difficult for many language combinations and operating systems. Because of the need to associate a concurrency policy with an addressable entity used in a source code representation, concurrency policy related errors require a change to the source code.

The process of controlling the order of access to addressable entities as described is known as concurrency control and is performed by today's systems using language specific techniques; such as JAVA's “serialized” keyword, system provided functions in an object code library with language specific APIs that perform operations on “locks” and “semaphores” when called by a program, and through software transactional memory that also requires language specific features. That is, this type of control must be coded into software at the source code level. Code requiring concurrency control is often a source of errors and is difficult to debug because multiple threads or processes of execution are involved. Fixing an error requires a change to one or more source code files, necessitating the rebuilding of at least one executable.

Accordingly, there exists a need for methods, systems, and computer program products for providing concurrency control for addressable entities.

### SUMMARY

Methods and systems are described for providing concurrency control for addressable entities. In one aspect, a concurrency policy is associated with an addressable entity in an executable program component generated from source code, the concurrency policy controlling an order of access by a plurality of runtime processes each executing machine code instructions for accessing the addressable entity, the machine code instructions generated from source code, wherein the concurrency policy is associated with the addressable entity independent of the source code of the executable program component and the source code of the machine code instructions. An attempt to access the addressable entity by a machine code instruction executed by a runtime process of the plurality of runtime processes is detected. The machine code instruction is allowed to access the addressable entity based on the concurrency policy.

According to an aspect, a system for providing concurrency control for addressable entities is disclosed. The system includes means for associating a concurrency policy with an addressable entity in an executable program component generated from source code, the concurrency policy controlling an order of access by a plurality of runtime processes each executing machine code instructions for accessing the addressable entity, the machine code instructions generated from source code, wherein the concurrency policy is associated with the addressable entity independent of the source code of the executable program component and the source code of the machine code instructions. The system also includes means for detecting an attempt to access the addressable entity by a machine code instruction executed by a runtime process of the plurality of runtime processes. The system also includes means for allowing the machine code instruction to access the addressable entity based on the concurrency policy.

According to another aspect, a system for providing concurrency control for addressable entities is disclosed. The system includes an entity access monitor component configured for associating a concurrency policy with an addressable entity in an executable program component generated from source code, the concurrency policy controlling an order of access by a plurality of runtime processes each executing machine code instructions for accessing the addressable entity, the machine code instructions generated from source code, wherein the concurrency policy is associated with the addressable entity independent of the source code of the executable program component and the source code of the machine code instructions. The system further includes an access detector component configured for detecting an attempt to access the addressable entity by a machine code instruction executed by a runtime process of the plurality of runtime processes. The system also includes a concurrency enforcer component configured for allowing the machine code instruction to access the addressable entity based on the concurrency policy.

According to still another aspect, a computer readable medium including a computer program, executable by a machine, for providing concurrency control for addressable entities is disclosed. The computer program comprising executable instructions for associating a concurrency policy with an addressable entity in an executable program component generated from source code, the concurrency policy controlling an order of access by a plurality of runtime processes each executing machine code instructions for accessing the addressable entity, the machine code instructions generated from source code, wherein the concurrency policy is associated with the addressable entity independent of the source code of the executable program component and the source code of the machine code instructions. The computer program further includes instructions for detecting an attempt to access the addressable entity by a machine code instruction executed by a runtime process of the plurality of runtime processes. The computer program includes instructions for allowing the machine code instruction to access the addressable entity based on the concurrency policy.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a flow diagram illustrating a method for providing concurrency control for addressable entities according to an embodiment of the subject matter described herein;

FIG. 2 is a block diagram illustrating a system for providing concurrency control for addressable entities according to another embodiment of the subject matter described herein;

FIG. 3 is a block diagram illustrating a system for providing concurrency control for addressable entities according to another embodiment of the subject matter described herein;

FIG. 4 illustrates an exemplary Extensible Markup Language (XML) document for associating concurrency policies with addressable entities according to another embodiment of the subject matter described herein;

FIG. 5 is a data flow diagram illustrating data flow in a system for providing concurrency control for addressable entities according to another embodiment of the subject matter described herein;

FIG. 6 is a data flow diagram illustrating data flow in a system for providing concurrency control for addressable entities according to another embodiment of the subject matter described herein;

FIG. 7 illustrates an exemplary loadable object file for associating concurrency policies with addressable entities according to another embodiment of the subject matter described herein;

FIG. 8 is a flow diagram illustrating a method for providing concurrency control for addressable entities according to an embodiment of the subject matter described herein; and

FIG. 9 is a block diagram illustrating a system for providing concurrency control for addressable entities according to another embodiment of the subject matter described herein.

### DETAILED DESCRIPTION

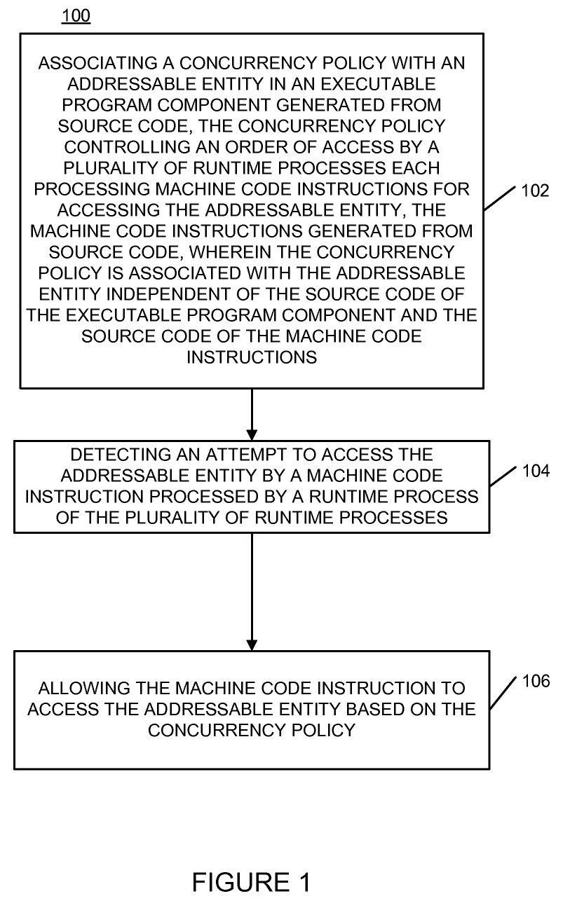

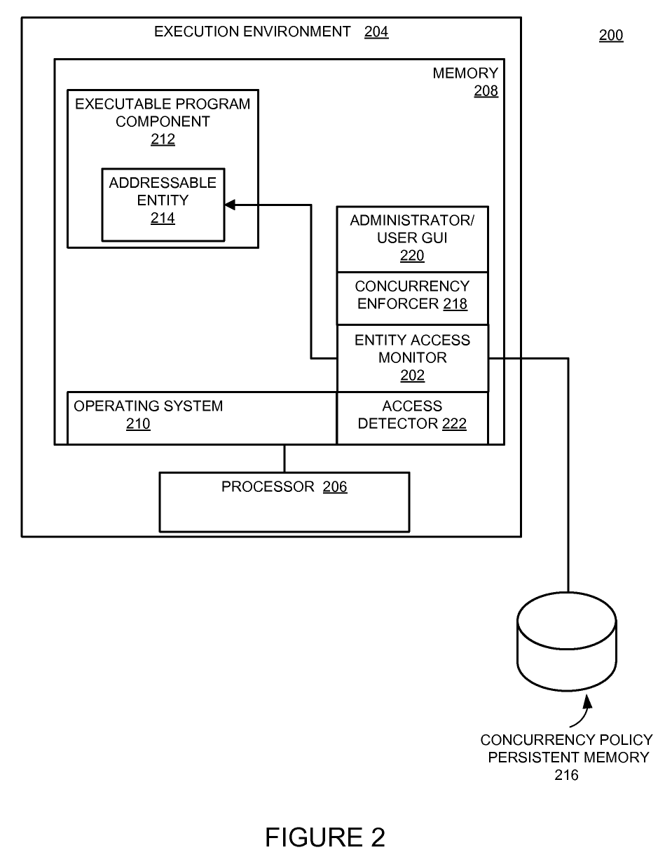

FIG. 1 is a flow diagram illustrating a method for providing concurrency control for addressable entities according to an exemplary embodiment of the subject matter described herein. FIG. 2 is a block diagram illustrating a system 200 for providing concurrency control for addressable entities according to another exemplary embodiment of the subject matter described herein. The method illustrated in FIG. 1 can be carried out by, for example, some or all of the components illustrated in the exemplary system of FIG. 2.

With reference to FIG. 1, in block 102 a concurrency policy is associated with an addressable entity in an executable program component generated from source code. The concurrency policy controls an order of access by a plurality of runtime processes each executing machine code instructions for accessing the addressable entity, the machine code instructions generated from source code. The concurrency policy is associated with the addressable entity independent of the source code of the executable program component and the source code of the machine code instructions. Accordingly, a system for providing concurrency control for addressable entities includes means for associating a concurrency policy with an addressable entity in an executable program component generated from source code. The concurrency policy is for controlling an order of access by a plurality of runtime processes each executing machine code instructions for accessing the addressable entity. The machine code instructions are generated from source code. The concurrency policy is associated with the addressable entity independent of the source code of the executable program component and the source code of the machine code instructions. For example, as illustrated in FIG. 2, an entity access monitor component 202 is configured for associating a concurrency policy with an addressable entity in an executable program component generated from source code. The concurrency policy is for controlling an order of access by a plurality of runtime processes each executing machine code instructions for accessing the addressable entity. The machine code instructions are generated from source code. The concurrency policy is associated with the addressable entity independent of the source code of the executable program component and the source code of the machine code instructions.

The system 200 depicted in FIG. 2 includes an execution environment 204 for use in associating a concurrency policy with an addressable entity. The execution environment 204 can include a processor 206, a memory 208, and an operating system 210. Memory can be either virtual or physical memory accessible via a processor using memory addresses from a processor supported address space. Memory can also be associated with an address space of a virtual execution environment such as virtual machine (VM) hosted by the execution environment 204. An executable program component 212 can be loaded into a location in the memory 208 as shown.

Addressable entities including the addressable entity 214 in the executable program component 212 are loaded into and thereby associated with respective memory locations in memory 208. An addressable entity is a portion of an executable program component 212 specified in a source code language that is addressable within a compatible execution environment. Examples of addressable entities can include variables including structures, constants including structured constants, functions, subroutines, methods, classes, anonymous scoped instruction sets, and individual instructions that can be labeled. An instance of an addressable entity includes a value or an instruction, but it is not the value or the instruction. Addressable entities can have a number of corresponding representations. These representations include source code, object code, and any intermediate representations used by an interpreter, compiler, linker, loader, or equivalent tool. When in an execution environment, an addressable entity is instantiated prior to becoming accessible. Some addressable entities can have a plurality of associated instances in an execution environment at any given time. In the context of an executable environment, a single source code specified addressable entity can correspond to one or more instances accessible within the execution environment. The terms “addressable entity” and “instance” are used interchangeably in this document.

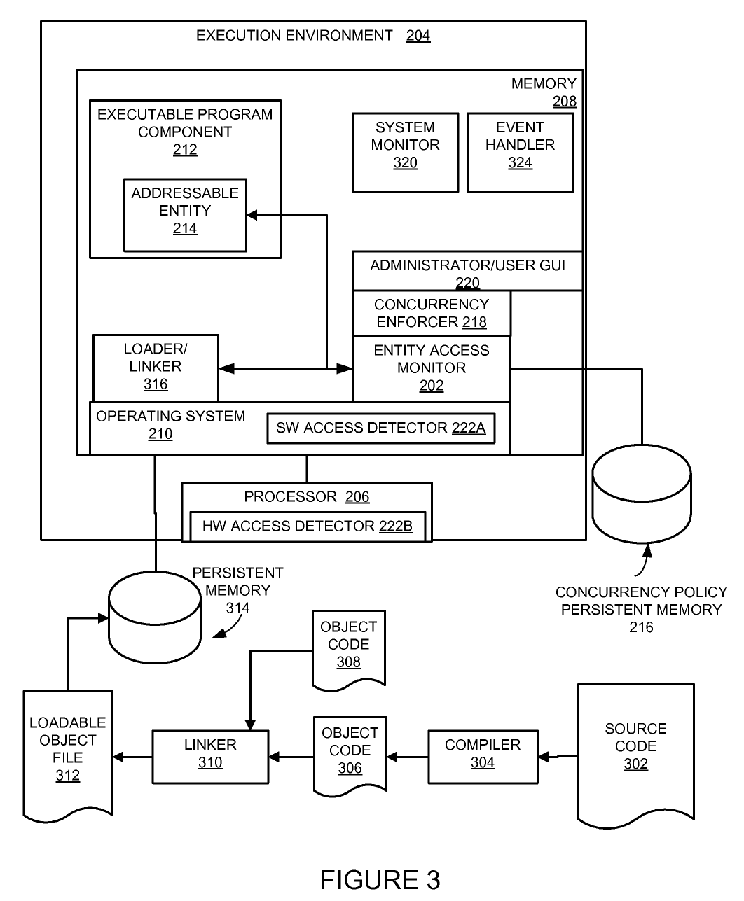

FIG. 3 illustrates a system 300 for, among other things, generating the executable program component 212 including the addressable entity 214. In FIG. 3, a source code representation 302 is compiled using a compiler 304 resulting in an object code representation 306. The object code 306 includes a set of instructions and data elements that can be prepared for linking prior to loading, are loadable into an execution environment, or are loaded into an execution environment. When in an execution environment, object code can be linked, or object code can include one or more unresolved references. The object code representation 306 can be linked, if needed, with another object code representation 308 generated from another source code representation using a linker 310 for producing a loadable object code representation 312. The loadable object code representation 312 can be stored in a persistent memory 314 capable of storing loadable objects.

In another aspect, the source code representation 302 of the executable program component 212 can be represented in a processor independent source code programming language, wherein a plurality of machine code instructions, each executable by a processor from a specified architecture family, can be generated from the source code representation 302 written in the programming language. For example, the executable program component 212 is an executable representation of a source code representation, which can be written in a processor-independent programming language as source code. Some examples of processor-independent programming languages include JAVA, C, C++, Basic, Perl, and Ruby. A processor independent programming language is a programming language from which a plurality of machine code representations can be generated from a single source written using the programming language where each respective machine code representation is compatible for execution by a respective processor from a different processor family, such as the INTEL® x86 processor family and the POWERPC® processor family. That is, a machine code representation of the source can be generated that is executable on a processor from a particular processor family and a machine code representation can be generated that is executable on a processor of a second processor family. As such, a source code representation written in a processor-independent programming language can be used to generate an executable representation capable of being run in an execution environment supported by a processor from a family other than the family of the processor 206.

The executable program component 212 can be created by the process of loading the loadable object file 312 into a memory location in the memory 208 using a loader/linker 316. During the process of loading, the loader/linker 316 reserves memory locations that can be associated with addressable entities of the executable program component 212. The association of memory locations with addressable entities can occur as each addressable entity is instantiated. Values associated with instantiated addressable entities can be stored in the memory location of each addressable entity as provided by the loader/linker 316 at load time. If the executable program component 212, including the addressable entity 214, includes any unresolved references, then a load-time or run-time linking process can be performed by a linking component of the loader/linker 316 to resolve the unresolved references. Once the references are resolved, a runtime process is able to execute the machine code instructions included in the executable program component 212 using the processor 206.

As discussed above, a concurrency policy is associated with the addressable entity 214. The concurrency policy is used to control an order of access to the addressable entity 214 by a plurality of runtime processes. A runtime process is an instance of an executable program component that is being executed. A runtime process includes the execution of machine code instructions of one or more executable program components by a processor. More than one runtime process can execute an executable program component or share an addressable entity of an executable program component.

Each runtime process includes the execution of machine code by the processor 206. The machine code executed by a runtime process is generated from a source code representation that includes an instruction or a plurality of instructions capable of accessing an addressable entity, such as the addressable entity 214 during execution of the instruction or plurality of instructions by the processor 206. The source code representation can include a source code instruction that references the addressable entity 214 using a name or symbol for the addressable entity 214. The symbol can be resolved to a memory address of the loaded addressable entity 214 by at least one of the compiler 304, the linker 310, the loader 316, and an interpreter. Once the symbol is resolved, a machine code representation of the source code instruction can access the addressable entity 214 when executed by the processor 206.

In another aspect, associating a concurrency policy with an addressable entity includes selecting the concurrency policy for association with the addressable entity 214 according to an attribute of the addressable entity 214. For example, the entity access monitor component 202 can be configured for selecting the concurrency policy for association with the addressable entity 214 according to an attribute of the addressable entity 214. In another aspect, the attribute of the addressable entity 214 includes at least one of a value attribute, a data type attribute, a scope attribute, and a symbol attribute including an identifier of the addressable entity 214. The entity access monitor component 202 can be configured to use an attribute of the addressable entity 214 such as its symbol or data type to locate a matching concurrency policy stored in a memory, such as a concurrency policy persistent memory 216. The entity access monitor component 202 can provide a runtime process identifier, information associated with the addressable entity 214, and concurrency policy information from the located concurrency policy to a concurrency enforcer component 218.

The entity access monitor component 202 and a concurrency enforcer component 218 can associate and enforce a concurrency policy without regard for the source code language used to generate the machine code executed by a runtime process. In another aspect, the concurrency policy specifies an order of access by a plurality of runtime processes with instructions not supported by a programming language of the source code representation 312 of the executable program component 212 and the source code of the machine code instructions. For example, a language with no syntax for concurrency control or no library support for concurrency control can have a concurrency policy associated with an addressable entity where the addressable entity is generated from a source code representation written in the language. The concurrency policy can provide functionality that the source code language and associated code libraries do not support. For example, JAVA supports only serialized access to addressable entities allowing one runtime process at a time to execute a method. An exemplary concurrency policy can allow multiple concurrent runtime processes access to an addressable entity included in a JAVA program.

In another aspect, associating a concurrency policy with an addressable entity includes associating the concurrency policy with a memory location associated with the addressable entity. An access detector 222 can be configured to detect an attempt to access the memory location. For example, the entity access monitor component 202 is configured for associating the concurrency policy with a memory location associated with the addressable entity. An access detector 222, according to an aspect described below, can include a memory management system (MMS) component (not shown) including hardware and/or software components. The MMS is configured for detecting an attempt to access the memory location. The association of a memory location with an addressable entity allows the entity access monitor component 202 and the concurrency enforcer component 218 to determine whether a memory access is associated with an addressable entity having a concurrency policy.

The use of a source code representation, such as the source code representation 302 is not required in determining the association between a memory location and an addressable entity, nor is the use of a source code representation required in making the association between the addressable entity and the concurrency policy. Active participation of the associated executable program component 212 including the monitored addressable entity 214 is also not required.

In another aspect, associating a concurrency policy with an addressable entity can include associating a concurrency system with the addressable entity for controlling an order of access to the addressable entity. Concurrency systems can include a non-locking arrangement, for example, as used in software transactional memory (STM) where no locking occurs. For example, the entity access monitor component 202 can be configured for associating a concurrency system with the addressable entity 214 for controlling an order of access to the addressable entity 214. Further, an execution environment condition can be detected during the processing of the executable program component 212, and the concurrency system can be associated with the addressable entity 214 based on the detected execution environment condition. For example, a system monitor component 320 can be configured for detecting an execution environment condition, such as a processor threshold, during the processing of the executable program component 212, and wherein the entity access monitor component 202 can be configured for associating the concurrency system with the addressable entity 214 is based on the detected execution environment condition.

A concurrency policy can exist in various formats including data or executable components. Some concurrency policies support a fixed set of concurrency policies. The set of concurrency policies can include one concurrency policy that is used in all cases or a plurality of concurrency policies where a concurrency policy is associated with an addressable entity by configuration. A concurrency policy can be selected based on an attribute of the addressable entity, an attribute of one or more of the runtime processes, or any execution environment attribute. For example, a concurrency policy associated with an addressable entity can specify a maximum number of runtime processes allowed to access the addressable entity concurrently. Another concurrency policy can take into account whether an access by a runtime process is a read or a write access. For example, a concurrency policy can allow one writer of the addressable entity 214 at any given time and allow multiple readers of the addressable entity 214 at a given time. Further, a concurrency policy can use a non-locking arrangement, for example, as used in software transactional memory (STM) where no locking occurs. An execution environment condition such as processor utilization measure can be used in a concurrency policy to specify a change in concurrency policy based on an execution environment condition such as a comparison of the processor utilization measure with a threshold. For example, a concurrency policy can be specified that causes a switch from a concurrency system based on a lock mechanism to a concurrency system based on a non-locking mechanism based on, for example, a measure of disk input/output activity of a plurality of runtime processes.

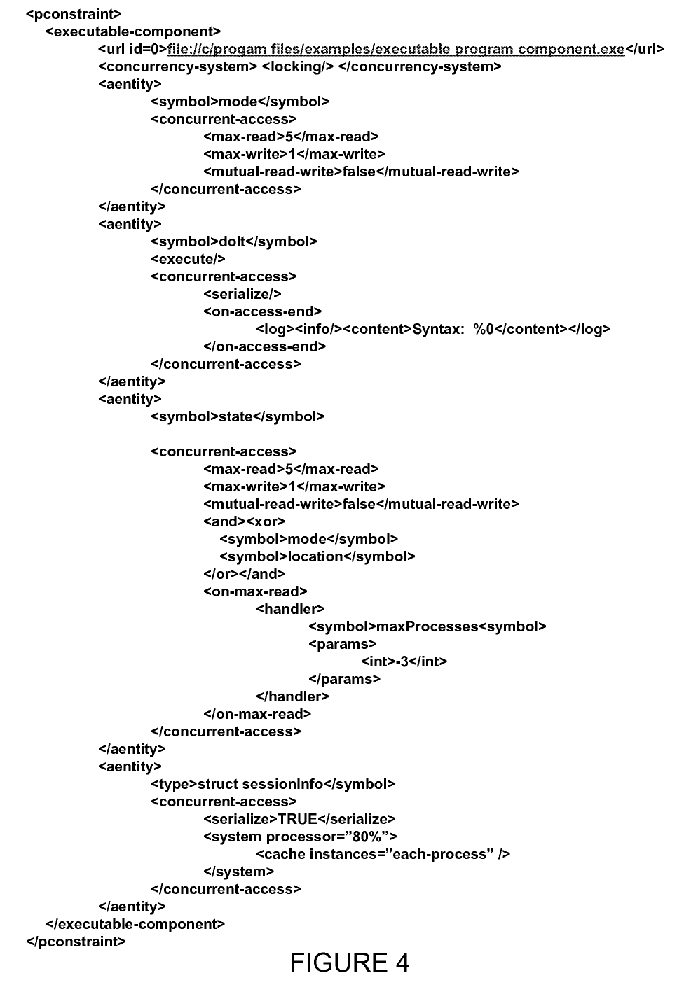

FIG. 4 illustrates an exemplary XML document for specifying a concurrency policy. The XML document can be used by the entity access monitor component 202 in associating the specified concurrency policy with an addressable entity included in the executable program component 212. FIG. 4 illustrates a <pconstraint> XML document, which includes <executable-component> elements each corresponding to an executable program component such as the executable program component 212. An executable program component can include an addressable executable entity also referred to as a code block. A code block can refer to any set of executable instructions, which are addressable as an executable unit. Examples of code blocks can include functions, subroutines, methods associated with classes, labeled instructions that can be the target of “jump” or “goto” instructions, and anonymous code blocks such as a while loop.

Each <executable-component> element includes a URI or URL that identifies the loadable program component associated with the executable program component 212. The <executable-component> elements can include a <concurrency-system> element allowing for the specification of a particular type of concurrency system such as a system that uses locks or a system that does not use locks, if supported by the execution environment 204.

The <executable-component> elements in the illustrated example further include <aentity> elements. Each <aentity> element can include elements specifying a matching criteria for associating one or more addressable entities in the executable program component 212 based on matching criteria included in the <aentity> element such as a matching criteria for matching a data type of an addressable entity in the executable program component 212. The <aentity> elements can be nested to specify a scope matching criteria of each addressable entity matched by a particular <aentity> element. For a language where all addressable entities have global scope the <aentity> elements can appear in the same level of the document. The <aentity> elements can include a <symbol> element for identifying an addressable entity or a plurality of instances of an address entity with a matching symbol or name. In an aspect, the use of wildcard characters, regular expressions, and/or other techniques can be used for pattern recognition in matching a symbol. Pattern recognition can be used in other matching criteria elements as will be clear to those skilled in the art given the description provided here. Data type information can be provided for identifying the data type of an addressable entity, such as integer, byte, instruction, character, class, and structures. Language neutral data type specification syntax can be used. Language specific data type symbols and syntax can be used in other aspects. Data type information can be used to identify addressable entities of the specified data type as associated with the concurrency policy specified in the <aentity> element. Service Oriented Architecture Protocol (SOAP), for example, allows data type information to be associated with entities in a remote procedure call specification in a language neutral manner using an analogous XML schema. In fact, the SOAP schema and namespace can be used in an example of a format for specifying a concurrency policy. Resource definition framework (RDF) can also be used for supporting a schema for generating and processing a concurrency policy. A combination of attributes of an addressable entity including symbol/name, data type information, and runtime process owner, for example, can be specified for identifying addressable entities with matching attributes, associating the matching addressable entities with the concurrency policy specified in the <aentity> element.

In the example illustrated in FIG. 4, four sets of addressable entities are identified based on matching criteria and each is associated with a concurrency policy. The matching addressable entities are identified by one or more of associated attributes such as a symbol and/or data type attribute. The concurrency policy entries match addressable entries that have an associated symbol or name of “mode” a global variable; an associated symbol of “doit”, a code block; an associated symbol of “state”, another global variable; and have a data type of “struct sessionInfo”, a data type identifier. The addressable entity 214 in FIG. 2 is discussed below as an addressable entity matching one of the concurrency policy specifications in FIG. 4 for purposes of describing the operation of one or more examples.

A matching addressable entity with a symbol “mode” must also have a global scope because the <aentity> element appears in the outermost level of the <aentity> hierarchy. A <concurrent-access> element is included for specifying a concurrency policy associated with an addressable entity with a symbol name matching “mode,” specified as matching criteria. A <max-read> element is provided as part of a concurrency policy specification that specifies the maximum number of run-time processes that can access a matching addressable entity concurrently for read access. In one example, read access and execute access are equivalent, since both require reading of a memory location associated with an addressable entity. Other examples provide for finer-grained access. A <max-write> element is provided that specifies the maximum number of run-time processes that can access a matching addressable entity concurrently for writing to the memory location associated with the addressable entity. A <mutual-read-write> element is provided to indicate whether concurrent read and write access is allowed. The “false” value indicates that the two access types are mutually exclusive.

In another aspect, the concurrency policy can require serialized access to a matching addressable entity, wherein an access to the addressable entity by a first runtime process of the plurality of runtime processes prevents access to the addressable entity by a second runtime process of the plurality of runtime processes while the first process has access. For example, when the concurrency policy requires serialized access to the addressable entity, the concurrency enforcer component 218 can be configured for preventing access to the addressable entity by a second runtime process of the plurality of runtime processes in response to an ongoing access to the addressable entity by a first runtime process of the plurality of runtime processes. In the example illustrated in FIG. 4, an addressable entity matching the “doIt” entry is a code block as identified by the <execute> element. That is, the <execute> and <symbol> elements specify matching criteria. A <concurrent-access> element can include a <serialize> element specifying at least a portion of a concurrency policy indicating that the concurrency enforcer component 218 is to serialize access to a matching “doIt” code block. That is, as discussed above, only one runtime process can execute a matching “doIt” code block at a time.

FIG. 4 also illustrates some examples of advanced concurrency policy elements. For example, the entry for an addressable entity with the symbol “state” is similar to the entry for an addressable entity with the symbol “mode” including a <max-read> element, a <max-write> element, and a <mutual-read-write> element analogous to those described above. An <and> element is also included including a nested <xor> element. In the depicted example, the <and> element indicates that a runtime process must have access to both a “state” addressable entity and exactly one of a “location” addressable entity (not shown) and a <mode> addressable entity at the same time in order to match the matching criteria. The ability to specify relationships through the use of elements such as the <and>, <xor>, and <or> (not shown) is useful in preventing deadlock situations without having to provide code in the source code representation 302 of the addressable entity 214 or the source code representation of the machine code instructions for accessing the addressable entity 214.

FIG. 4 includes a fourth exemplary entry that is associated with addressable entities of the executable program component 212 that are of the type “struct sessionInfo.” A matching criteria <type> element can allow a concurrency policy to be associated with a number of addressable entity instances depending on the executable program component 212 as can other matching criteria elements described above. The <type> element and the <symbol> element can be used together to further narrow the addressable entities that match as indicated. For example, an element identifying an addressable entity or set of addressable entities in a given scope such as the scope of a particular code block or file module can be used to identify matching criteria for associating a concurrency policy with an addressable entity. Elements for specifying data type information and value constraints can be used for identifying an associated addressable entity or entities for which the concurrency policy applies. Those skilled in the art will see that other matching criteria and concurrency policy elements can be used. Thus, the elements described herein do not constitute an exhaustive list.

FIG. 4 also illustrates support for event handling as illustrated by the <on-max-read> element and the <on-access-end> elements. The <on-max-read> element is processed when the number of concurrent readers of the addressable entity 214 is determined to be the specified maximum. An exemplary, generic event handler is provided using a <handler> element that identifies a code block to be invoked and any parameters to pass when a matching criteria associated with the event handler in the context of a match of the <aentity> element matching criteria is detected. The “maxProcesses” code block is invoked to reduce the maximum number of runtime processes controlled by the executable component to be reduced by three, in the example depicted in FIG. 4. The concurrency policy entry associated with the “doIt” code block includes an event handler <on-access-end> that can be invoked when a runtime process completes executing of the “doIt” addressable entity. The event handler can be any specifiable executable such as an execution environment provided handler for logging a message to a default or configured log.

A concurrency policy can be received through file import, via a network connection, via a user interface 220, or via any other input techniques. Each concurrency policy can be stored for use during execution of various runtime processes in a persistent data store, such as the concurrency policy persistent memory 216. An exemplary concurrency policy can be based on a template that can be edited by an administrator/user graphical user interface (GUI) 220. A concurrency policy can be created without affecting the source code representation of any associated addressable entities or source code representations from which machine code can be generated capable of accessing the addressable entity when executed in a corresponding machine code representation by the processor 206. A concurrency policy can be generated manually by a user including the developer of the executable program component 212. A user of the executable program component 212 can also create a concurrency policy or edit an existing concurrency policy. A concurrency policy can be changed without updating the source code of the executable program component such that the program does not have to be regenerated.

Returning to FIG. 1, in block 104 an attempt to access the addressable entity by a machine code instruction executed by a runtime process of the plurality of runtime processes is detected. Accordingly, a system for providing concurrency control for addressable entities includes means for detecting an attempt to access the addressable entity by a machine code instruction executed by a runtime process of the plurality of runtime processes. For example, as illustrated in FIG. 2, an access detector component 222 is configured for detecting an attempt to access the addressable entity by a machine code instruction executed by a runtime process of the plurality of runtime processes.

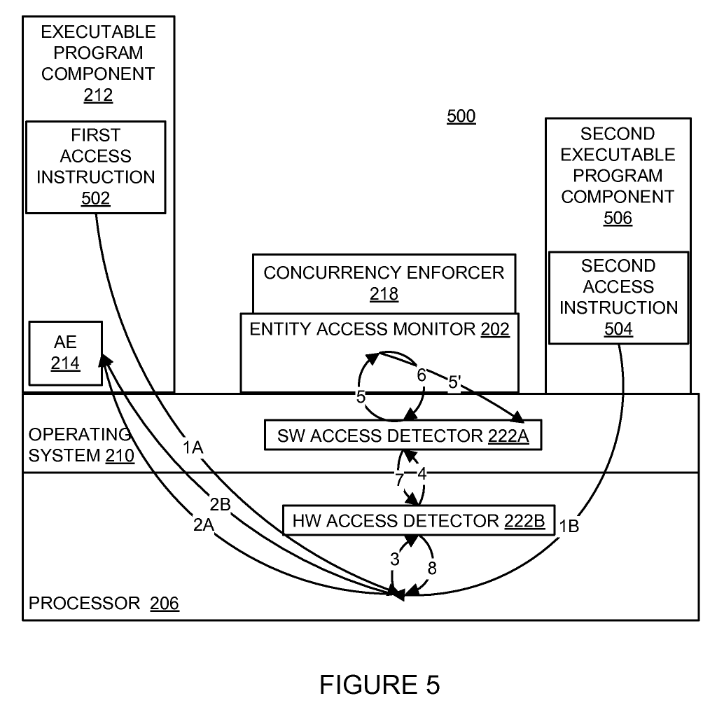

As further illustrated in FIG. 3 and FIG. 5, the exemplary access detector component 222 can include a software access detector component 222a. Alternatively, or in addition, the access detector component 222 can include a hardware access detector component 222b configured to detect an attempt to access the addressable entity. An access to an addressable entity can include the operations of reading from and writing to a memory location. Operations that read to or write from a memory location can include: loading and storing data into and from a processor register, copying content from a first memory location to a second memory location, deleting an association between an addressable entity and a memory location, and creating a association between an addressable entity and a memory location. Executing the contents of a memory location can include reading an instruction from a memory location, so an execution access can be viewed as a type of read access.

For example, as illustrated in FIG. 5, an access to a monitored addressable entity 214 is attempted by a first access instruction 502 of a first runtime process executing a machine code instruction of the executable program component 212. In the illustrated example, a second access instruction 504 also requires access to the addressable entity 214 in the processing of a second runtime process executing machine code of a second executable component 506. The attempt to access by the first access instruction 502 is illustrated as messages 1A and 2A. The attempt to access by the second access instruction 504 is illustrated as messages 1B and 2B. A message can be in the form of a call, interrupt, signal, data passed via a pipe, message queue, or network transmission, for example.

In another aspect, detecting an attempt to access the addressable entity 214 can include invoking an interceptor in response to detecting the attempt to access the addressable entity 214, the interceptor transferring control to a concurrency enforcer. For example, the access detector component 222 can be configured for invoking the entity access monitor 222 as an interceptor configured for transferring control to the concurrency enforcer component 218 in response to detecting the attempt to access the addressable entity 214. An exemplary interceptor can be invoked as an interrupt handler. The interrupt can be triggered by an access to a monitored memory location as described below.

The executing of each access instruction 502 and 504 within processor 206 causes, as illustrated by message 3, the hardware access detector 222b to generate an interrupt shown as message 4. The hardware access detector 222b can maintain monitoring information for use in determining whether an accessed memory location is designated as monitored, thus causing message 4. The software access detector 222a can be registered as the interrupt handler, in the example. Thus, the software access detector 222a is invoked to handle the interrupt as shown by message 4. The software access detector 222a can pass control and access information received via the interrupt from hardware access detector 222b to the entity access monitor component 202 depicted as message 5. Alternatively, the hardware access detector 222b can signal the software access detector 222a without interrupting the processing of the processor 206. The software access detector 222a and the entity access monitor component 202 can be associated with a second processor (not shown) allowing the software access detector 222a and the entity access monitor component 202 to operate in parallel to the executable program component 212. Through the use of instruction look-ahead, the entity access monitor component 202 can perform at least a portion of its monitoring of the memory location of the addressable entity 214 prior to an actual access. Access detection and monitoring can be performed prior to an access, after an access, or during an access, as is the case in the current example depending of the capabilities of a runtime process, the execution environment 102, and an exemplary entity access monitor.

The access detector component 222 can be configured to determine that a detected access is an access of a monitored memory location. Determining that a detected access is an access of a monitored memory location can be accomplished by the hardware access detector 222b, the software access detector 222a, or can require the interaction of both depending on the execution environment. The software access detector 222a can be a separate application, a supporting subsystem of an operating system, a component of an entity access monitor, an application included in operating system 210. The hardware access detector 222b can be included in the processor 206 or a separate hardware component.

Detection of an access to a monitored memory location can be made, for example, by detecting a memory access and comparing the address of the access against a list of monitored memory addresses held in a table. Determining an addressable entity associated with the memory location of a detected access can be performed, for example, through the use of a memory map of the executable program component 212 including the monitored addressable entity 214. A memory map can be made usable by the loader 316 and execution environment 204 by adding to the memory map, for example, the starting addresses and attribute information of code, data, stack and heap segments/spaces as addressable entity instances are instantiated. The initial memory map provides sufficient information to allow an access detector 222 to determine the memory locations associated with addressable entities in memory 208 at load-time. Attribute information for any global and static variables, constants, code blocks including functions, object methods, subroutines, labeled instructions, and anonymous code blocks (e.g. in ‘C’ all instructions between unnamed matching “{ }” symbols such as in a “while” loop are unnamed code blocks with their own scope) can be included in the memory map. As addressable entities are instantiated and destroyed during execution, the memory map can be updated.

For new memory locations allocated from stack space associated with newly instantiated addressable entities, the fact that a stack frame includes the return address of an addressable entity which caused the instantiation along with the memory map of a code segment of an executable program component 212 including the return address allows the entity access monitor component 202 to determine the invoked addressable entity 214. Additionally, the address of the invoked addressable entity 214 can be included in a register of the processor 206 allowing the access detector component 222 to determine the invoked addressable entity using a memory map. This information allows the access detector component 222 to determine memory locations of addressable entities in a stack frame associated with each code block addressable entity.

For new memory locations allocated for an executable program component 212 heap space, calls to library/execution environment routines that allocate, free, and/or otherwise manage an executable program component's associated heap space can be detected via the access detector component 222 detecting access to execution environment heap management routines or by configuring the memory management routines when invoked to invoke the access detector 222. The stack frame of each heap management routine can be used as above to determine the code block invoking a heap management routine. Using this information and a memory map that associates addressable entity type information, for example, with an addressable entity having an address in the memory map corresponding to the association of a heap memory entity with an instance of the addressable entity corresponding to the type information, an access detector is able to determine that the heap memory entity is associated with a specific addressable entity type. More sophisticated access detectors can be configured to detect access to specified addressable entities created at runtime as will be described.

A determination that a memory access is associated with an addressable entity can be made prior to an occurrence of a detected access, during a detected access, or after a detected access. In the system 200, the entity access monitor component 202 can receive control as result of a detected access to a monitored memory location of the addressable entity 214 by a runtime process. The memory entity access monitor component 202 can use the memory address and the memory map generated as described above to identify the addressable entity 214 to be accessed. Using an attribute of the addressable entity, the entity access monitor component 202 can determine whether a concurrency policy with a matching criteria specification is stored in the concurrency policy persistent memory 216. If no matching policy exists, the runtime process is allowed to continue. If a matching concurrency policy is located, for example the concurrency policy entry for the “doIt” code block, concurrency policy information, runtime process information, and addressable entity information can be provided to the concurrency enforcer component 218 for enforcement of the specified concurrency policy.

In another aspect, detecting an attempt to access the addressable entity 214 by a machine code instruction includes determining a type of access associated with the machine code instruction. Based on the detected type of access and the concurrency policy, the machine code instruction can be allowed to access the addressable entity 214. For example, the access detector component 222 can be configured for determining a type of access associated with the machine code instruction. The concurrency enforcer component 218 can be configured for allowing the machine code instruction to access the addressable entity based on the type of access associated with the machine code instruction and the concurrency policy.

In another aspect, an attempt to access the addressable entity by a machine code instruction executed by a runtime process of the plurality of runtime processes can be detected. In response to detecting the attempt to access the addressable entity 214 by the machine code instruction, an event handler component 324 can be invoked based on the concurrency policy. For example, the access detector component 222 can be configured for, in response detecting an attempt to access the addressable entity 214 by the machine code instruction executed by the runtime process of the plurality of runtime processes, invoking the event handler component 324 based on the concurrency policy. The event handler component 324 can be configured for performing an action associated with a machine code instruction, examples of which are described above in reference to FIG. 4.

Returning to FIG. 1, in block 106 the machine code instruction is allowed to access the addressable entity based on the concurrency policy. Accordingly, a system for providing concurrency control for addressable entities includes means for allowing the machine code instruction to access the addressable entity based on the concurrency policy. For example, as illustrated in FIG. 2, the concurrency enforcer component 218 is configured for allowing the machine code instruction to access the addressable entity based on the concurrency policy.

In FIG. 5 both the first runtime process executing the first access instruction 502 of the executable component 212 and the second runtime process executing the second access instruction 504 of the second executable component 506 require access to the addressable entity 214 as indicated by the messages 1A and 1B. As discussed above, the accesses are detected by the access detector 222 and relayed to the entity access monitor component 202 as indicated by messages 4 and 5. The entity access monitor component 202 locates a concurrency policy associated with access to the addressable entity 214 by each of the first and the second runtime processes. As discussed above, according to an aspect, the concurrency enforcer component 218 can be configured for controlling an order of access to the addressable entity with instructions not supported by a programming language of the source code of the executable program component and the source code of the machine code instructions.

For example, the addressable entity 214 can be the “doIt” code block associated with the concurrency policy indicated in FIG. 4. The “doIt” concurrency policy entry illustrated in FIG. 4 indicates that access is serialized. That is, only one runtime process at a time is allowed to access and execute the “doIt” code block. The concurrency enforcer component 218 determines whether other runtime processes are waiting to access the “doIt” code block. If there are other processes, the concurrency enforcer component 218 places each of the first and second runtime process in a wait state. If there are no waiting processes, the concurrency enforcer component 218 determines whether the “doIt” routine is currently being executed by another runtime process. If another runtime process is performing the “doIt” code block, the first and second runtime processes are placed in a wait state. If no runtime process is executing the “doIt” routine, the concurrency enforcer component 218 uses concurrency policy information to determine the next runtime that is allowed to access the addressable entity 214 from the plurality of runtime processes including the first runtime process, the second runtime process, and any other waiting processes.

If there is no explicit information in the concurrency policy specification, a default concurrency policy can be used. In the example, a default concurrency policy uses the order in which the concurrency enforcer component 218 receives information concerning each runtime process related to access of the addressable entity 214, the priority of the addressable entity 214, and the time the runtime process has been in a wait state. For example, the concurrency enforcer component 218 can maintain a wait queue for each priority level. When information relating to an access to the addressable entity 214 by a runtime process is received, the concurrency enforcer component 218 can place information identifying the runtime process on the end of a queue matching the runtime process's priority. When the addressable entity 214 is available for access, the concurrency enforcer component 218 allows the runtime process at the head of the queue with the highest priority level to resume execution.

For example, if the first runtime process is at the head of the highest priority queue, it will be placed in a “run” state allowing executing of the first access instruction 502 that accesses the addressable entity 214 depicted as message 2A. Message 2A is allowed in the depicted system 500 by messages 6, 7, and 8 that are returns for function calls and interrupts that led to an invocation of the concurrency enforcer component 218. Alternatively, control can be passed directly to the first access instruction 502 by the concurrency enforcer component 218 making the messages 6, 7, and 8 unnecessary. The concurrency enforcer component 218 can communicate with an operating system 210 scheduler for managing the process queues. Runtime processes on lower priority queues are allowed to run when no higher priority runtime processes are waiting. The concurrency enforcer component 218 can use a timer to “promote” a runtime process from a lower priority queue to a higher priority queue, so that all runtime processes accessing the addressable entity 214 are allowed access. For example, if the second runtime process is a low priority runtime process it is placed on a low priority queue, but will eventually be allowed to access the addressable entity, indicated as the message 2B, depending on the number of accesses by higher priority runtime processes while it waits and the time the second runtime process is in a wait state on one of the wait queues. While the use of a default concurrency policy is described, a scheduling policy can be identified in a concurrency policy specification such as FIG. 4 by, for example, providing a symbol element for the scheduling policy. For example, a <schedule> element can be used and assigned values known to the concurrency enforcer component 218 or a plugin of the concurrency enforcer component 218, such as “FIFO,” and “round-robin.”

When a runtime process completes access to an addressable entity 214 associated with a concurrency policy, such as the “doIt” code block and the corresponding concurrency policy entry in FIG. 4, the entity access monitor component 202 is notified. The processor 206 can include a flag that, when set, generates an interrupt whenever a stack frame is released supporting an aspect using a hardware access detector 222B. The interrupt can be generated prior to release of the stack frame or after. The interrupt signals the end of executing of a code block associated with a concurrency policy. The concurrency enforcer component 218 can set the stack frame release interrupt flag in one aspect. The entity access monitor component 202 can be a registered interrupt handler of stack frame release interrupts. The entity access monitor component 202 again associates the code block of the released stack frame with a concurrency policy using information in the concurrency policies stored in the concurrency policy persistent memory 216. The entity access monitor component 202 can invoke the concurrency enforcer component 218, passing information identifying the addressable entity and the concurrency policy. The concurrency enforcer component 218 performs actions associated with release of the addressable entity by a runtime process base on information in the concurrency policy.

In the case of the “doIt” code block as illustrated in FIG. 4, a log handler is invoked when access to the “doIt” routine is completed by a runtime activity allowing the log handler to log a message based on the addressable entity and the runtime process in most cases. In practice, any message can be logged and other actions can be invoked in addition to or instead of a logging action. Calls to pre-access and post-access handlers are depicted as message 5′ in FIG. 5. Another example, of a user of pre and post handlers, involves setting a timer just prior to allowing access and checking the time just after the access to collect statistics indicating, for example, how much processing time is spent accessing the associated addressable entity overall and by the runtime process. Pre-handlers and post-handlers can also be used to determine the number of runtime processes waiting on compute statistics, allowing a system administrator to adjust the policy.

If a concurrency policy is associated with a memory access where the associated addressable entity 214 is not a code block, completion of the memory access, a read or a write, is detectable, for example, using an access monitor 222 operating in an analogous manner to that used for detecting accesses to instructions in code blocks. The concurrency enforcer component 218 can communicate with the operating system 210 in placing runtime processes in a wait state and allowing them to execute, as discussed above. Process information, available from the scheduler or other operating system 210 component, such as priority and identity are used in some concurrency policies for determining the order of access to an addressable entity when supported by the system.

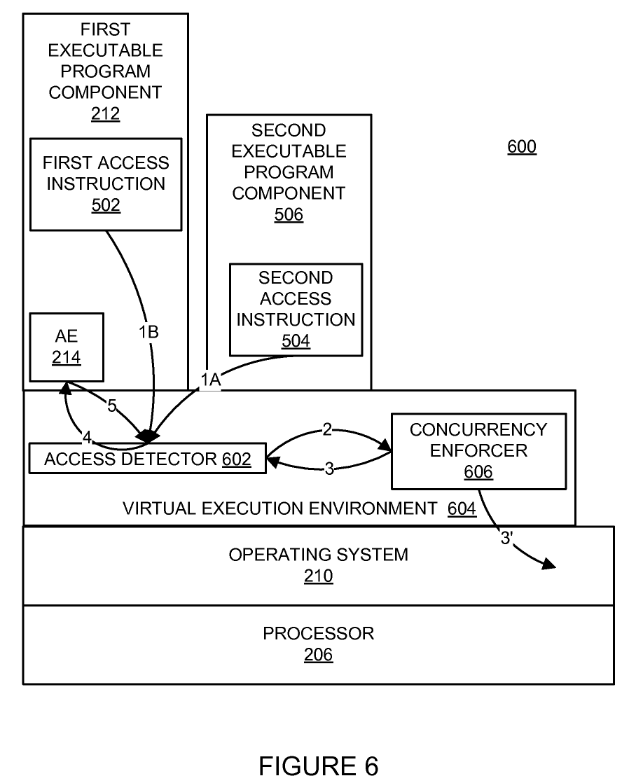

According to another aspect, FIG. 6 depicts a system 600 similar to system 500 in FIG. 5 including the processor 206, the operating system 210, the first executable program component 212 including the addressable entity 214 and the first access instruction 502, the second executable program component 506 including the second access instruction 504 that when executed by the processor 206 attempts to access the addressable entity 214.

System 600 differs from system 500 in that the software access monitor 222a and the hardware access monitor 222b are replaced by an access detector 602 included in the virtual execution environment 604. Virtual execution environments are well-known and include virtual environments which emulate hardware environments allowing, for example, a processor specific operating system or other processor specific executable to run on an unsupported processor; or allowing one operating system to be hosted by another operating system, or to support a language specific environment such as the JAVA Runtime Environment (JRE) and Smalltalk's runtime environment.

U.S. patent application Ser. No. 11/428,273 filed Jun. 30, 2006, entitled “Methods, Systems, And Computer Program Products For Providing A Program Execution Environment,” the entire disclosure of which is here incorporated by reference, describes an operating-system-hosted, language-neutral execution environment supporting at least one of a virtual, non-sequential address space and a virtual, structured address space. Further, U.S. patent application Ser. No. 11/428,338 filed Jun. 30, 2006, entitled “Methods, Systems, And Computer Program Products For Providing Access To Addressable Entities Using A Non-Sequential Virtual Address Space,” the entire disclosure of which is here incorporated by reference, describes providing access to addressable entities using a non-sequential virtual address space. The virtual execution environment 604 can provide memory management for at least a portion of addressable entities such as addressable entity 214 and the first and second access instructions 302, 304 included in the executable program component, such as the first executable program component 212, and the second executable program component 302 of which a portion operates under the control of the virtual execution environment 604. The virtual execution environment 604 allows instructions executed in a runtime process using addresses from an address space of the virtual execution environment 604 to access memory locations managed by the virtual execution environment 604 by translating the virtual execution environment 604 addresses to the underlying address space of the host operating system 210 and the processor 206 operating with the host execution environment 204, thereby allowing access to the associated addressable entity.

Access can be configured via a memory management system of the operating system 210 and the processor 206. As such, the virtual execution environment 604 is capable of detecting accesses by runtime process executing instructions using addresses from the address space of the virtual execution environment 604. The virtual execution environment 604 includes the access detector 602, which determines whether an access is associated with a memory location associated with a monitored addressable entity managed by the virtual execution environment 604. Additionally, the virtual execution environment 604 includes a concurrency enforcer 606 compatible with the virtual execution environment 604 operating along with or instead of the concurrency enforcer component 218 in the system 200.

For example, a first runtime process executing machine code instructions of the first executable component 212 including the first access instruction 502, executed within in the context of the virtual execution environment 604 hosted by execution environment 204 using the operating system 210 and the processor 206, causes an access to the memory location of the addressable entity 214 through the virtual execution environment 604 using the virtual execution environment address of the memory location. Similarly, a second runtime process executing machine code instructions of the second executable component 212 including the second access instruction 504, executed within the context of the virtual execution environment 604 using the operating system 210 and the processor 206, causes an access to the memory location of the addressable entity 214 through the virtual execution environment 604 using the virtual execution environment address of the memory location The initial access attempts by the first and second access instructions 302, 304 are depicted as messages 1A and 1B, respectively. The access detector 602, including an entity access monitor (not shown), determines whether a concurrency policy is associated with each of the accesses of the addressable entity 214 based on, for example, information included in a memory map of the virtual execution environment 604 virtual memory in a manner similar to the determination described above.

In a virtual execution environment 604 and in an aspect where the execution environment 204 uses features of an structured data storage system (SDSS), for example using an SQL Database Management System (DBMS), as described in U.S. patent application Ser. No. 11/428,273 and in U.S. patent application Ser. No. 11/428,338, addressable entities can be stored in columns and rows of data base tables. SQL DBMSs have the ability to control access to the data managed by the DBMS and to enforce concurrency requirements specified by a concurrency policy supported by the DBMS.

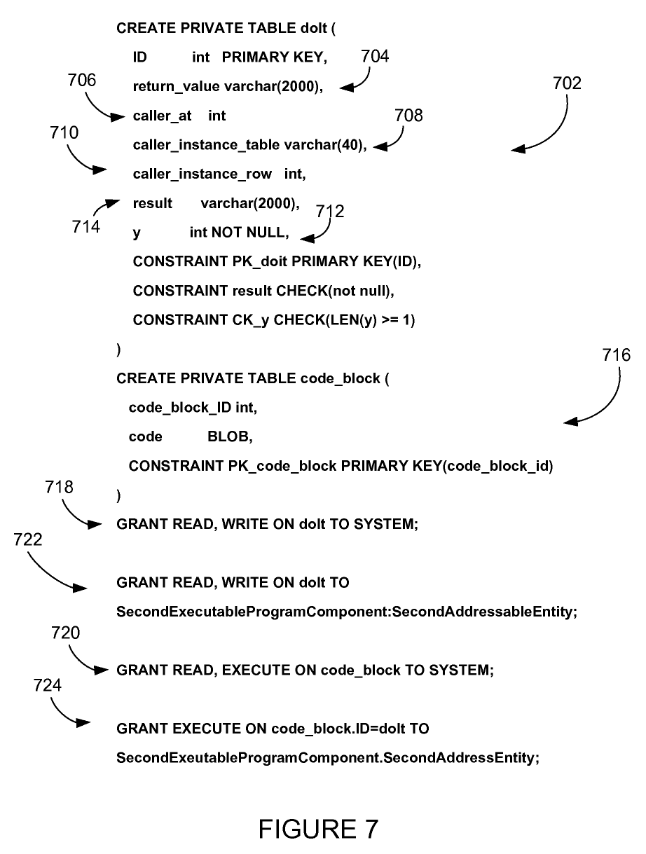

FIG. 7 illustrates a possible example of a portion of a loadable object file as described above. The example can be described in terms of the virtual execution environment 604 as depicted in FIG. 6 using a structured and/or non-sequential address space as described in U.S. patent application Ser. No. 11/428,273 or the execution environment 204 as depicted in FIG. 5 in an aspect using a structured and/or sequential address space as described in U.S. patent application Ser. No. 11/428,338. The example shows instructions used by a loader to create an instance table for the first addressable entity 214, such as the “doIt” code block 702. As can be seen, the “doIt” code block instance table includes a column for a return value, return_value 704; three columns identifying the invoking code block and return address, caller_at 706, in a caller_instance_table 708 and a caller_instance_row 710; an input parameter, y 712; and an instance variable, result 714. A “CREATE PRIVATE TABLE” command 716 includes at least a portion of a concurrency policy identified by the PRIVATE keyword that instructs the DBMS to make each record private to each instance, in effect serializing access to each record in the corresponding table. In an alternate aspect for serializing access to a code block stored in a record in a “code_block” table, such as the code_block table record associated with an identifier corresponding to the “doIt” code block instance table, only one record is allowed in the “doIt” code block instance table when the executable program component 212 is loaded and executed. With only one instance of a record in the “doIt” code block instance table, the DBMS PRIVATE keyword depicted in the “CREATE PRIVATE TABLE “doit” command 702 ensures that only one runtime process can access the “doIt” function at a time, thus serializing access. Although the PRIVATE keyword is depicted in both create table commands 702 726, its depiction on the two tables is merely illustrative, since only one of the “PRIVATE” keywords is necessary for specifying a concurrency policy for serializing access the “doIt” executable addressable entity in the code_block table.

Following table creation, additional constraint commands are included. The first GRANT command 718 grants read and write access to “doIt” instances to the SYSTEM principal allowing each execution environment 204 or 604 to use the single instance record allowed as described; created at the time the first executable program component 212 is loaded into the memory 208 based on the address space of each execution environment 204 or 604. The third GRANT command 720 gives the SYSTEM principal execute access to the code_block table allowing the machine code in each row of the table to be accessed and executed by the processor 206 when executed under the authority of the SYSTEM ID. The second GRANT command 722 allows an addressable entity, SecondAddressableEntity, including the second access instruction 504, in the second executable program component 506, SecondExecutableProgramComponent, to read and write data from and to records of firstAddressableEntity 214, “doIt” code block instance table, thus allowing a runtime process executing the machine code of the second executable program component 506 to access the data portion of the addressable entity 214, “doIt.” The fourth GRANT command 724 allows the addressable entity, SecondAddressableEntity including the second access instruction 504, in the second executable program component, 506 SecondExecutableProgramComponent, access to a record in the code block table corresponding to the code block associated with the firstAddressableEntity function, “doIt” 214 executed by the processor 206. The second and fourth GRANT commands 722 and 724 allow the second access instruction 504 of the secondAddressableEntity to invoke the firstAddressableEntity 214 as a function. According to an aspect, instructions included in the executable program component 212 are granted authority for accessing and executing the “doIt” addressable entity 214 by default.

In addition to using SQL commands to provide and enforce a concurrency policy, additional columns and tables can be used for supporting concurrency features not supported by a particular DBMS and/or other supporting data store. For example, a code block table can include a column for storing a reference to a concurrency policy specified, for example, in a manager analogous to FIG. 4 discussed above. In a system using such features, the matching of attributes at run-time, as described above, is not required. Further, the referenced concurrency policy is enforced by a concurrency enforcer component 218 providing a concurrency feature not provided by the DBMS used providing a function not provided by the supporting DBMS or other data store used. For example, the concurrency policy can be associated with a column of a row rather than an entire row or table.

Systems using an SDSS to support an execution environment virtual or otherwise do not require a conventional memory map. The SDSS is configured to determine the mapping of addressable entities to memory addresses and associated memory locations. An SDSS requires no data not included in a loadable object file compatible with the SDSS to determine which addressable entity a memory location is associated with when at least a portion of an executable program entity is loaded into the execution environment including the SDSS. This frees such systems from having to maintain memory maps that consume system resources.

Regardless of whether execution environment 204 or execution environment 604 is used, the access of the memory location associated with the addressable entity 214 by a first runtime process including executing of the first access instruction 502 and by a second runtime process including executing of the second access instruction 504 are detected by the execution environment 204 or execution environment 604 as illustrated by the messages 1A and 1B depicted in FIGS. 5 and 6. For example, an SDSS based execution environment can be invoked by machine code generated from source code by a compiler, linker, loader, and/or interpreter to access an addressable entity specified by and generated from the source code and stored in the memory managed by the SDSS, and is thus detected by the SDSS since accesses can be mediated by the SDSS. The access detector 222 in execution environment 204 or the access detector 602 in execution environment 604 determines whether the access is for a memory location of a monitored addressable entity. The addressable entity 214 is a monitored entity in this example as identified by the concurrency policy provided to either the execution environment 204 or the execution environment 604. The concurrency policy in a SDSS based execution environment can use concurrency related keywords and directives included in data store supported commands such as SQL commands in the loadable object file such as the PRIVATE keyword discussed above. As a result, the access detector 222 or the access detector 602 signals concurrency enforcer 218 or concurrency enforcer 606 respectively to enforce an associated concurrency policy as represented, for example, by the message 2 in FIG. 6.

According to an aspect, the systems illustrated in FIGS. 5 and 6 can use a SDSS. In such a system, at least a portion of the concurrency enforcer is included in the SDSS. The messages 2, 3, 3′, 4, and 5 are sent for each of the messages 1A and 1B in the system 600. In the exemplary SDSS based execution environment 204 or 604, at least a portion of the concurrency enforcer 218 or concurrency enforcer 606 can be an SDSS concurrency monitor mechanism such as those currently provided in a DBMS. If the concurrency enforcer 218 or concurrency enforcer 606 detects an access to an SDSS memory location such as a DBMS table and/or row with associated an associated concurrency policy, the SDSS concurrency monitor, including the concurrency enforcer 218 or concurrency enforcer 606, can enforce the concurrency policy and control the order of access by accessing runtime processes according to the specified concurrency policy. A DBMS, for example, can include at least a portion of the SDSS concurrency enforcer 218 or concurrency enforcer 606, entity access monitor 202 or the entity access monitor 602, and the access detector 222 or the access detector 602. The message 3′ in FIG. 6 represents any pre-access or post-access handlers specified by the concurrency policy in the virtual execution environment 604. In an SDSS based system, database triggers can be used to invoke the specified handlers, if any.

In the exemplary SDSS based version of the system 600, the execution environment 204 hosting the virtual execution environment 604 provides access via a register or by mapping a virtual execution environment address to an address of the underlying address space of the operating system 210 and/or processor 206 as described in U.S. patent application Ser. No. 11/428,273.

When the concurrency enforcer 218 or the concurrency enforcer 606 determines a next runtime process allowed to access the addressable entity 214 as discussed above, the runtime process is placed in a “run” state allowing it to continue processing causing a return from the concurrency enforcer 218 or the concurrency enforcer 606 processing to the access detector 222 or the access detector 602 as illustrated by a message 3 in FIG. 6 in the case of the system 600. The access detector 222 or the access detector 602 then allows the executing of the access instruction 502 or the access instruction 504 to proceed. In the system 600 this is as indicated by the message 4. The executing of the access instructions results in an attempt to access the addressable entity 214. The access detector 222 or the access detector 602 detects an access of a memory location by the runtime process that indicates that access to the addressable entity 214 is complete. This detecting of a completed access is depicted as the message 5 in the system 600. The detection allows the access detector 222 or the access detector 602 to notify the concurrency enforcer 218 or the concurrency enforcer 606. The concurrency enforcer 218 or the concurrency enforcer 606 as a result determines a next runtime process allowed to access the addressable entity 214, if there are any waiting runtime processes.

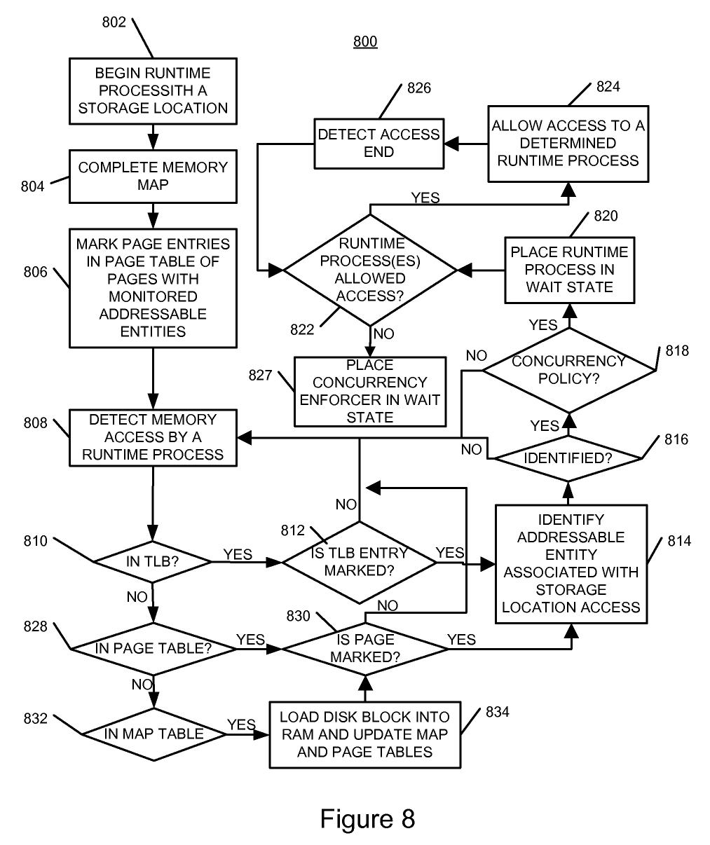

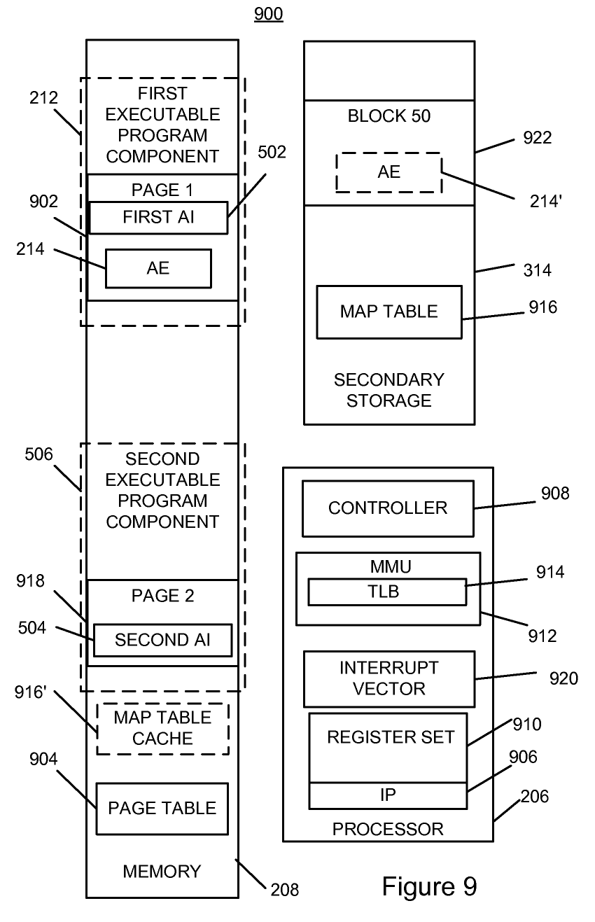

FIG. 8 is a flow chart of a method 800 consistent with the method 100 in FIG. 1 carried out by a system such the system 200 depicted in FIGS. 2, 3 and 5 including a memory management system (MMS) which includes both hardware and software components. A system 900 in FIG. 9 illustrates an exemplary MMS and other components configured to perform the method 800 in an aspect of the system 200 depicted in FIGS. 2, 3, and 5.

In block 802, a runtime process associated with an executable program component loaded into a memory is initiated. The executable program component includes an addressable entity associated with a memory location as described above. The system 900 includes the memory 208, which can be virtual or physical with an address space compatible with the processor 206. The first executable program component 212 including the addressable entity 214 is loaded into the memory 208 for processing in the context of the runtime process begun in block 802. The executable program component 212 can span one or more pages of a supported paged memory system. The addressable entity 214 is included in the page 902.

In block 804, a memory map including at least information associated with the monitored addressable entity 214 is created or completed from an incomplete map generated by build tools used in generating the first executable program component 212, if required. A complete memory map can already exist depending on the executable program component and the particular implementation of the system performing the method 800. For example, in the systems 900 and 300, as the first executable program component 212 is loaded into the memory 208 by the loader 316, the loader 316 creates or completes an existing memory map using at least address information associated with addressable entity 214. The memory map is made available to the entity access monitor component 202 and the access detector 222.

In block 806, entries in a page table 904 are marked for monitoring if the associated memory page includes a monitored addressable entity. Either an accessed and/or accessing addressable entity can be marked depending on the particular implementation. In the systems 900, 300, and 500 the loader 316 marks the page entry in the page table 904 for the page 902. Alternately, the marking can be done by a component of the memory management system such as a page table manager (not shown).

A runtime process identifier of the process begun in block 802 is generated by or provided to the operating system 210 allowing the runtime process to be started. In the system 900 the first access instruction 502 of the first executable program component 212 in processing of the runtime process is loaded into an instruction pointer (IP) 906 of the processor 206 and executed by microcode in a controller 908. The first access instruction 502 can include an operand referencing a register in a register set 910 of the processor 206 and can access a location in the memory 208 via the memory management system comprising a memory management unit (MMU) 912 with a table lookaside buffer (TLB) 914, the page table 904, and optionally a map table 916 and a corresponding cache 916′ described below. The second access instruction 504 included in the second executable program component 506 executed by the runtime process initiated in block 802 and/or by a second runtime process is loaded into the memory 208 in a second page, page 2 918, of the system 900. The second access instruction 504 includes an operand corresponding to the address of the memory location of the addressable entity 214.

In block 808, a memory access by the runtime process begun in block 802 or another runtime process is detected. In the system 900, an access is detected, for example, when an access to the addressable entity 214 is by an access attempt to the memory location of the addressable entity as an instruction via reference to the memory location stored in the instruction pointer (IP) 906 for loading the content of the addressable entity as a machine code instruction into the processor 206. Access can also be detected when executing of an instruction by the controller 908 causes the processor 206 to attempt to access the memory location of the addressable entity 214 referenced as an operand of the instruction. For example, the controller 908 in executing the second access instruction 504 of the second executable component 506 where the instruction includes an operand with a value corresponding to an address of the addressable entity 214 causes the processor 206 to initiate an access to the addressable entity 214. Both the loading of the second access instruction 504 and the subsequent access of the addressable entity 214 can be detected by at least a portion of the components of the memory management system previously listed.

In block 810, the detected memory access causes the MMU 912 to check for an entry in the TLB 914 corresponding to the memory address being accessed. If a corresponding entry is included in the TLB 914, a determination is made whether the entry is marked for monitoring in block 812. For example, in the system 900, the second access instruction 504 executed by microcode in the controller 908 where the second access instruction 504 includes a memory address corresponding to a memory location of the addressable entity 214 causes the MMU 912 to check the TLB 914 for an entry corresponding to the memory address. When a corresponding entry in the TLB 914 is found, the MMU 912 detects whether the entry is marked for monitoring.

When a marked entry is detected, control passes to block 814 where the addressable entity 214 associated with the accessed memory location is identified. A marked entry corresponding to the memory address of the memory location of the addressable entity 214 causes the processor 206 to generate an interrupt using an interrupt vector 920. According to an aspect, the interrupt vector 920 includes an entry associated with an interrupt causing execution flow to invoke a software access detector 222a as an interrupt handler causing a process analogous to the process described above in connection with FIG. 3 to be performed passing control to the entity access monitor 202 for performing block 814 as described above.

Next, in block 816, if an addressable entity is not identified the process returns to block 808 to detect a next memory access by a runtime process. Otherwise, the method continues to block 818. An entry in the TLB 914, the page table 904, the map table 916, and/or the map table cache 916′ can be marked for a variety of reasons. In an exemplary system that uses marking for more than one purpose, block 818 determines why the mark exists. For example, the entity access monitor 202 in performing block 818 determines whether a concurrency policy is associated with the identified addressable entity 214.

A method and system for associating a concurrency policy with an addressable entity has been described above. If a concurrency policy is not associated with the identified addressable entity 214 as determined in block 818 processing returns to block 808. If the addressable entity 214 is associated with a concurrency policy, processing proceeds to block 820. In block 820, the runtime process is placed in a wait state, in an aspect, if other runtime processes are also waiting to access the addressable entity 214 and if the addressable entity 214 is not currently otherwise accessible. Block 820 can be performed by at least one of the entity access monitor component 202 and the concurrency enforcer component 218. The method proceeds to block 822 where a determination is made by the concurrency enforcer 218 which, if any, of the waiting runtime processes can access the addressable entity 214. Systems for performing this determination have been described above. When the concurrency enforcer component 218 determines a next runtime process or runtime processes that can access the addressable entity 214, processing proceeds to block 824 where the determined runtime process is placed in a run state allowing the access instruction 502 or the access instruction 504, depending on the runtime process, to be processed by the processor 206 resulting in an access of the addressable entity 214. As the runtime process completes its access of the addressable entity 214, the completion of the access is detected in block 826. The detection of the end of the access to the addressable entity 214 is reported to the concurrency enforcer component 218 causing the concurrency enforcer 218 to repeat the determination just described if there are runtime processes waiting. If there are no runtime processes waiting, then the concurrency enforcer component 218 can be put into a wait state at block 827.

Returning to block 810, if an entry for the memory address of the addressable entity 214 is not located in the TLB 914 the page table 904 is checked by the MMS in block 828 to determine whether an entry referencing a page including the accessed memory address is in the page table 904 indicating the location of the memory address in volatile physical memory of the memory 208 If an entry is located in the page table 904, the method proceeds to block 830 where a check is performed to determine if the page is marked. If the page is not marked, the method returns to block 808. If the page is marked the method proceeds to block 814 described above.

When using a memory 208 that spans both physical volatile memory and the physical persistent memory 314 in the execution environment 204 as described in U.S. patent application Ser. No. 11/428,338, at least a portion of memory 208 can be stored in the physical persistent memory 314. The mapping of a virtual address to the physical persistent memory 314 is configured by a map table 916 of which a portion can be stored in physical volatile memory as represented by a map table cache 916′. Entries in the map table 916 and the map table cache 916′ can be marked. Alternately, the blocks in the physical persistent memory 314 including memory areas associated with monitored addressable entities are marked. For example, the block 50 922 including a copy of the addressable entity 214′ can be marked or its entry in the map table 916 and the map table cache 916′ can be marked.

Returning to block 828, if an entry for the memory address of the addressable entity 214 is not located in the page table 904, the map table 916 and/or the cached map table 916′ is checked by the MMS in block 832 to determine whether an entry referencing, for example, a disk block that includes the accessed virtual memory address is in the map table 916 and/or the cached map table 916′ indicating the location of the virtual memory address on a hard drive. If an entry is located in the map table 916 and/or the cached map table 916′ the method proceeds to block 834. In block 834, the block is paged into volatile physical memory with corresponding entries in the map table 916 and/or the cached map table 916′ and the page table 904 updated accordingly. Processing then proceeds to block 830 as described above. If the accessed virtual address is not located in the map table in block 832 an address violation is reported to the operating system 210.

In the system 900, a hardware access detector is illustrated at least in part by the MMU 912, the TLB 914, the controller 908, and the interrupt vector 920. When the generated interrupt returns and access has been allowed, the MMU 912 provides information from the TLB 914 entry allowing the controller 908 to execute the instruction including the access to the memory location of the addressable entity 214 as indicated by the operation code of the machine code instruction and the operands of the instruction including the memory address of the memory location of the addressable entity 214.

As described above, the processing associated with block 814 determines whether the memory location identified by the memory address is monitored. In one aspect, this determination is made using a concurrency policy, which identifies at least one an addressable entity to be monitored or a set of addressable entities to be monitored according to the specified matching criteria. Further using a memory map to associate the memory location with an addressable entity and determining whether the associated addressable entity is specified in the concurrency policy as monitored. A second method of determining whether the memory location is monitored was also described above which used an SDSS backed memory management system. The remainder of the method proceeds from block 814 as described above.

Revisiting block 828, in conventional memory management systems, if a page is not located in a page table 904, it is an error. The page table 904 includes all pages within a processor accessible memory 208 whether they are currently mapped to physical memory or stored in a swap file, for example. In a system supporting an address space spanning both physical volatile memory and physical persistent memory, such as supported by an SDSS based system, the contents of portions or all of a virtual address space can survive a reboot of the system where the virtual addresses of the persistent portions of processor address spaces remain associated with the addressable entities through the reboot process. From another perspective, the system allows an addressable entity, which is loaded into processor address space to remain loaded through a system reboot. In such a method, a map table 916 can be used to manage the mapping of processor virtual memory, which is mapped to the physical persistent memory 316.

When a page is not located in the page table 904 in block 828, control can be passed to block 832 rather than causing an error condition as in conventional system. A process associated with block 832 locates the page in a map table 916 and/or the cached map table 916′, which identifies a physical memory location in persistent memory associated with the virtual memory location of the addressable entity 214 to be accessed. When the entry is located, the block is loaded into RAM and the page table 904 and the map table 916 and/or the cached map table 916′ are updated accordingly in block 832. The method proceeds to block 830 and proceeds as described above. In the system 900, if a page table entry is not located, a lookup operation is performed using the first map table cache 916′, and then the map table 916 if an entry is not located in the cache 916′. When an entry is located control is passed to block 814 where processing occurs as has been described.

If no marked address is located in the TBL 914, the page table 904, or the map table 916 and/or the cached map table 916′ the memory location associated with the memory address of the machine code instruction is not monitored and control is passed to block 808 while the runtime process of the accessing instruction is allowed to continue execution allowing access to the memory location of the addressable entity 214′. In the system 900, the memory location is accessed according the operation of the microcode in the controller 908, and processed.

It should be understood that the various components illustrated in the various block diagrams represent logical components that are configured to perform the functionality described herein and can be implemented in software, hardware, or a combination of the two. Moreover, some or all of these logical components can be combined, some can be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both.

Moreover, executable instructions of a computer program for carrying out the methods described herein can be embodied in any machine or computer readable medium for use by or in connection with an instruction execution machine, system, apparatus, or device, such as a computer-based or processor-containing machine, system, apparatus, or device, that can read or fetch the instructions from the machine or computer readable medium and execute the instructions.

As used here, a “computer readable medium” can be any medium that can contain, store, communicate, propagate, or transport the computer program for use by or in connection with the instruction execution machine, system, apparatus, or device. The computer readable medium can be, for example, but not limited to, an electronic, magnetic, optical, electromagnetic, infrared, or semiconductor machine, system, apparatus, device, or propagation medium. More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), (g), or (n) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

Thus, the subject matter described herein can be embodied in many different forms, and all such forms are contemplated to be within the scope of what is claimed. It will be understood that various details of the invention can be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for providing concurrency control for addressable entities, the method comprising:
associating a concurrency policy with an addressable entity in an executable program component generated from source code, the concurrency policy controlling an order of access by a plurality of runtime processes each executing machine code instructions for accessing the addressable entity, the machine code instructions generated from source code, wherein the concurrency policy is associated with the addressable entity independent of the source code of the executable program component and the source code of the machine code instructions;
detecting an attempt to access the addressable entity by a machine code instruction executed by a runtime process of the plurality of runtime processes; and
allowing the machine code instruction to access the addressable entity based on the concurrency policy.

2. The method of claim 1 wherein the source code of the executable program is in a processor independent programming language, wherein a plurality of machine code instructions, each executable by a specified processor from a different processor architecture family, can be generated from the source code.

3. The method of claim 1 wherein the concurrency policy controls an order of access by a plurality of runtime processes with instructions not supported by a programming language of the source code of the executable program component and the source code of the machine code instructions.

4. The method of claim 1 wherein associating a concurrency policy with an addressable entity includes selecting the concurrency policy for association with the addressable entity according to an attribute of the addressable entity.

5. The method of claim 4 wherein the attribute of the addressable entity includes at least one of a value attribute including an acceptable value of the addressable entity, a category attribute including a category of addressable entities associated with the addressable entity, a scope attribute including a section of the executable program component wherein the addressable entity is known, and a symbol attribute including an identifier of the addressable entity.

6. The method of claim 1 wherein associating a concurrency policy with an addressable entity includes associating a concurrency system with the addressable entity for controlling an order of access to the addressable entity.

7. The method of claim 6 including detecting an execution environment condition during the processing of the executable program component, wherein associating the concurrency system with the addressable entity is based on the detected execution environment condition.

8. The method of claim 1 wherein associating a concurrency policy with an addressable entity includes associating the concurrency policy with a memory location associated with the addressable entity, wherein a memory management system detects an attempt to access the memory location.

9. The method of claim 1 wherein the concurrency policy requires serialized access to the addressable entity, wherein an access to the addressable entity by a first runtime process of the plurality of runtime processes prevents access to the addressable entity by a second runtime process the plurality of runtime processes.

10. The method of claim 1 wherein
detecting an attempt to access the addressable entity by a machine code instruction includes determining a type of access associated with the machine code instruction, and
wherein allowing the machine code instruction to access the addressable entity is based on the type of access associated with the machine code instruction and the concurrency policy.

11. The method of claim 1 wherein detecting an attempt to access the addressable entity includes invoking an interceptor in response to detecting the attempt to access the addressable entity, the interceptor transferring control to a concurrency enforcer.

12. The method of claim 1 including
in response to detecting an attempt to access the addressable entity by a machine code instruction, invoking an event handler based on the concurrency policy.

13. A system for providing concurrency control for addressable entities, the system comprising:
means for associating a concurrency policy with an addressable entity in an executable program component generated from source code, the concurrency policy controlling an order of access by a plurality of runtime processes each executing machine code instructions for accessing the addressable entity, the machine code instructions generated from source code, wherein the concurrency policy is associated with the addressable entity independent of the source code of the executable program component and the source code of the machine code instructions;
means for detecting an attempt to access the addressable entity by a machine code instruction executed by a runtime process of the plurality of runtime processes; and
means for allowing the machine code instruction to access the addressable entity based on the concurrency policy.

14. A system for providing concurrency control for addressable entities, the system comprising:
an entity access monitor component configured for associating a concurrency policy with an addressable entity in an executable program component generated from source code, the concurrency policy controlling an order of access by a plurality of runtime processes each executing machine code instructions for accessing the addressable entity, the machine code instructions generated from source code, wherein the concurrency policy is associated with the addressable entity independent of the source code of the executable program component and the source code of the machine code instructions;
an access detector component configured for detecting an attempt to access the addressable entity by a machine code instruction executed by a runtime process of the plurality of runtime processes; and
a concurrency enforcer component configured for allowing the machine code instruction to access the addressable entity based on the concurrency policy.

15. The system of claim 14 wherein the source code of the executable program is in a processor independent programming language, wherein a plurality of machine code instructions, each executable by a specified processor from a different processor architecture family, can be generated from the source code.

16. The system of claim 14 wherein the concurrency enforcer component is configured for controlling an order of access to the addressable entity with instructions not supported by a programming language of the source code of the executable program component and the source code of the machine code instructions.

17. The system of claim 14 wherein the entity access monitor component is configured for selecting the concurrency policy for association with the addressable entity according to an attribute of the addressable entity.

18. The system of claim 17 wherein the attribute of the addressable entity includes at least one of a value attribute including an acceptable value of the addressable entity, a category attribute including a category of addressable entities associated with the addressable entity, a scope attribute including a section of the executable program component wherein the addressable entity is defined, and a symbol attribute including an identifier of the addressable entity.

19. The system of claim 14 wherein the entity access monitor component is configured for associating a concurrency system with the addressable entity for controlling an order of access to the addressable entity.

20. The system of claim 19 including a system monitor component configured for detecting an execution environment condition during the processing of the executable program component, and wherein the entity access monitor component is configured for associating the concurrency system with the addressable entity is based on the detected execution environment condition.

21. The system of claim 14 wherein the entity access monitor component is configured associating the concurrency policy with a memory location associated with the addressable entity, and including a memory management system component configured for detecting an attempt to access the memory location.

22. The system of claim 14 wherein the concurrency policy requires serialized access to the addressable entity, wherein the concurrency enforcer component is configured for preventing access to the addressable entity by a second runtime process the plurality of runtime processes in response to an access to the addressable entity by a first runtime process of the plurality of runtime processes.

23. The system of claim 14 wherein the access detector component is configured for determining a type of access associated with the machine code instruction, and wherein the concurrency enforcer component is configured for allowing the machine code instruction to access the addressable entity is based on the type of access associated with the machine code instruction and the concurrency policy.

24. The system of claim 14 including an interceptor component configured for transferring control to the concurrency enforcer component, wherein the access detector component is configured for invoking the interceptor component in response to detecting the attempt to access the addressable entity.

25. The system of claim 14 including an event handler component configured for performing an action associated with a machine code instruction, wherein the access detector component is configured for, in response detecting an attempt to access the addressable entity by a machine code instruction executed by a runtime process of the plurality of runtime processes, invoking the event handler component based on the concurrency policy.

26. A computer readable medium including a computer program, executable by a machine, for providing concurrency control for addressable entities, the computer program comprising executable instructions for:
associating a concurrency policy with an addressable entity in an executable program component generated from source code, the concurrency policy controlling an order of access by a plurality of runtime processes each executing machine code instructions for accessing the addressable entity, the machine code instructions generated from source code, wherein the concurrency policy is associated with the addressable entity independent of the source code of the executable program component and the source code of the machine code instructions;
detecting an attempt to access the addressable entity by a machine code instruction executed by a runtime process of the plurality of runtime processes; and
allowing the machine code instruction to access the addressable entity based on the concurrency policy.
